(19) United States
(12) Patent Application Publication
(10) Pub. No.: US 2026/0264007 A1
(43) Pub. Date: Sep. 10, 2026

(54) WORKING ELECTRODE, ELECTROCHEMICAL CELL, AND MANUFACTURING METHOD OF WORKING ELECTRODE

(71) Applicant: DENSO CORPORATION, Kariya-city (JP)

(72) Inventors: Hiroshi OKAMOTO, Kariya-city (JP); Junichi NARUSE, Kariya-city (JP)

(21) Appl. No.: 19/542,773

(22) Filed: Feb. 18, 2026

(30) Foreign Application Priority Data
Mar. 6, 2025 (JP) 2025-035268

(51) Int. Cl. B01D 53/32; B01D 53/62

(52) U.S. Cl. CPC B01D 53/326; B01D 53/62; B01D 2253/1124; B01D 2257/504

(57) ABSTRACT

A working electrode includes a substrate and a CO₂ adsorbent supported by the substrate. The CO₂ adsorbent is configured to bind to CO₂ contained in a CO₂-containing gas in response to an application of a voltage between a counter electrode and the working electrode, which causes electrons to be supplied from the counter electrode to the CO₂ adsorbent. The substrate is made of a non-carbon material. The CO₂ adsorbent is made of an inorganic material. The working electrode is substantially free of carbon.

### CROSS REFERENCE TO RELATED APPLICATION

The present application claims the benefit of priority from Japanese Patent Application No. 2025-035268 filed on Mar. 6, 2025. The entire disclosure of the above application is incorporated herein by reference.

### TECHNICAL FIELD

The present disclosure relates to a working electrode, an electrochemical cell including a working electrode, and a manufacturing method of a working electrode.

### BACKGROUND

Conventionally, electrochemical cells have been known that are used in carbon dioxide recovery systems that recover carbon dioxide (hereinafter also referred to as CO₂) from CO₂-containing gases such as exhaust gases and the atmosphere. Electrochemical cells include a working electrode having a CO₂ adsorbent capable of adsorbing and desorbing CO₂. The working electrode is also referred to as an adsorption electrode.

### SUMMARY

A working electrode according to one aspect of the present disclosure includes a substrate and a CO₂ adsorbent supported by the substrate. The CO₂ adsorbent is configured to bind to CO₂ contained in a CO₂-containing gas in response to an application of a voltage between a counter electrode and the working electrode, which causes electrons to be supplied from the counter electrode to the CO₂ adsorbent. The substrate may be made of a non-carbon material. The CO₂ adsorbent may be made of an inorganic material. The working electrode may be substantially free of carbon.

### BRIEF DESCRIPTION OF DRAWINGS

Objects, features and advantages of the present disclosure will become apparent from the following detailed description made with reference to the accompanying drawings. In the drawings:

FIG. 1 is a diagram illustrating a carbon dioxide recovery system according to a first embodiment;

FIG. 2 is a diagram illustrating a carbon dioxide recovery device in the first embodiment;

FIG. 3 is a diagram illustrating a working electrode in the first embodiment;

FIG. 4 is a diagram illustrating a surface of a working electrode substrate in the first embodiment;

FIG. 5A is a diagram for explaining the operation of the carbon dioxide recovery device in the CO₂ recovery mode in the first embodiment;

FIG. 5B is a diagram for explaining the operation of the carbon dioxide recovery device in the CO₂ discharge mode in the first embodiment;

FIG. 6 is a scanning electron microscope (SEM) image of a Cu₂O/SUS mesh working electrode in Experimental Example;

FIG. 7 is an enlarged SEM image of part VII in FIG. 6;

FIG. 8 is a diagram showing the LMM Auger electron peak of Cu in Experimental Example;

FIG. 9 is a diagram showing the 2p_{3/2} photoelectron peak of Cu in Experimental Example;

FIG. 10 is a diagram showing powder X-ray diffraction patterns of particles precipitated on a surface of a working electrode substrate in Experimental Examples 1 and 2;

FIG. 11 is a graph showing decomposition product concentrations in Example and Comparative Examples 1 and 2; and

FIG. 12 is a diagram illustrating a surface of a working electrode substrate in a second embodiment.

### DETAILED DESCRIPTION

Next, relevant technology is described to facilitate understanding of the following embodiments. A working electrode of an electrochemical cell may include a CO₂ adsorbent that adsorbs CO₂ by the Coulomb force of electrons. This CO₂ adsorbent is more likely to desorb CO₂ than materials that adsorb CO₂ through chemical bonds with specific elements (that is, bonds that share electron orbitals with CO₂). Therefore, it is possible to suppress a decrease in CO₂ adsorption capacity and a decrease in CO₂ recovery efficiency.

Incidentally, in a working electrode of an electrochemical cell, a CO₂ adsorbent, a conductive additive (a conductive material), and a binder may be mixed and may be applied to a substrate to ensure a conductive path within the working electrode. Carbon black may be used as the conductive additive, and polytetrafluoroethylene (PTFE) or polyvinylidene fluoride (PVDF) may be used as the binder.

An electrochemical cell used in a carbon dioxide recovery system is used in an open-air environment. However, as described above, the conductive additive and the binder are carbon materials, and therefore there is a possibility that they may undergo decomposition reactions with oxygen, water, and the like in an electrolyte.

A working electrode according to one aspect of the present disclosure includes a substrate and a CO₂ adsorbent supported by the substrate. The CO₂ adsorbent is configured to bind to CO₂ contained in a CO₂-containing gas in response to an application of a voltage between a counter electrode and the working electrode, which causes electrons to be supplied from the counter electrode to the CO₂ adsorbent. The substrate is made of a non-carbon material. The CO₂ adsorbent is made of an inorganic material. The working electrode is substantially free of carbon.

According to this configuration, it is possible to prevent the working electrode from undergoing a decomposition reaction with oxygen, water, and the like in a electrolyte.

The following will describe embodiments for carrying out the present disclosure with reference to the drawings. In each embodiment, parts corresponding to the elements described in the preceding embodiments are denoted by the same reference numerals, and redundant explanation may be omitted. When only a part of a configuration is described in an embodiment, another preceding embodiment may be applied to the other parts of the configuration.

When, in each embodiment, it is specifically described that a combination of parts is possible, the parts can be combined. Furthermore, unless there is a particular hindrance to such combination, it is also possible to partially combine the embodiments with each other, even if it is not expressly stated that such combination is possible.

Unless otherwise specified, such as by the phrase “one” or the like, at least one of each member or portion described with reference numerals is provided.

### First Embodiment

A first embodiment of the present disclosure will be described with reference to the drawings. In the present embodiment, an example in which a working electrode according to the present disclosure is used in an electrochemical cell of a carbon dioxide recovery system will be described.

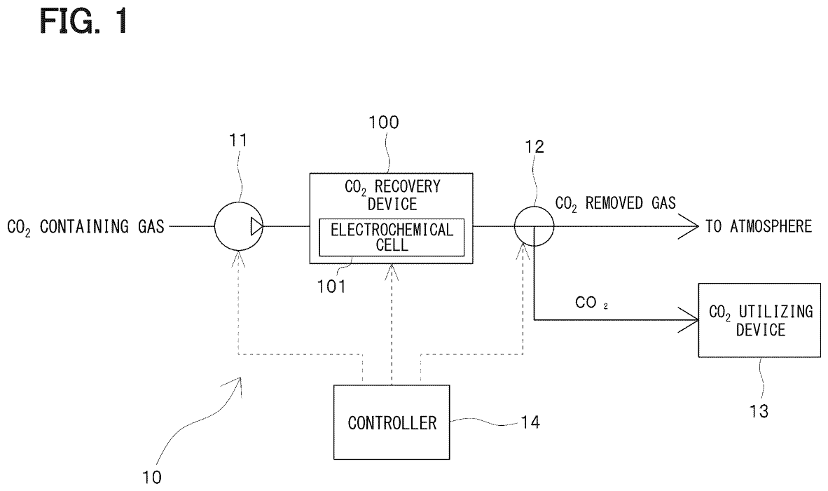

As shown in FIG. 1, a carbon dioxide recovery system 10 of the present embodiment includes a compressor 11, a carbon dioxide recovery device 100, a flow path switching valve 12, a carbon dioxide utilizing device 13, and a controller 14.

The compressor 11 pumps a CO₂-containing gas to the carbon dioxide recovery device 100. The CO₂-containing gas is a mixed gas that contains CO₂ and a gas other than CO₂. As the CO₂-containing gas, for example, air can be used.

The carbon dioxide recovery device 100 is a device that separates and recovers CO₂ from the CO₂-containing gas. The carbon dioxide recovery device 100 discharges a CO₂-removed gas that is gas after CO₂ is recovered from the CO₂-containing gas, or CO₂ recovered from the CO₂-containing gas. The configuration of the carbon dioxide recovery device 100 will be described in detail later.

The flow path switching valve 12 is a three-way valve that switches a flow path of exhaust gas from the carbon dioxide recovery device 100. When the CO₂-removed gas is discharged from the carbon dioxide recovery device 100, the flow path switching valve 12 switches the flow path of the exhaust gas toward the atmosphere. When CO₂ is discharged from the carbon dioxide recovery device 100, the flow path switching valve 12 switches the flow path of the exhaust gas toward the carbon dioxide utilizing device 13.

The carbon dioxide utilizing device 13 is a device that utilizes CO₂. The carbon dioxide utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the carbon dioxide recovery device 100, a flow path switching control of the flow path switching valve 12 and the like.

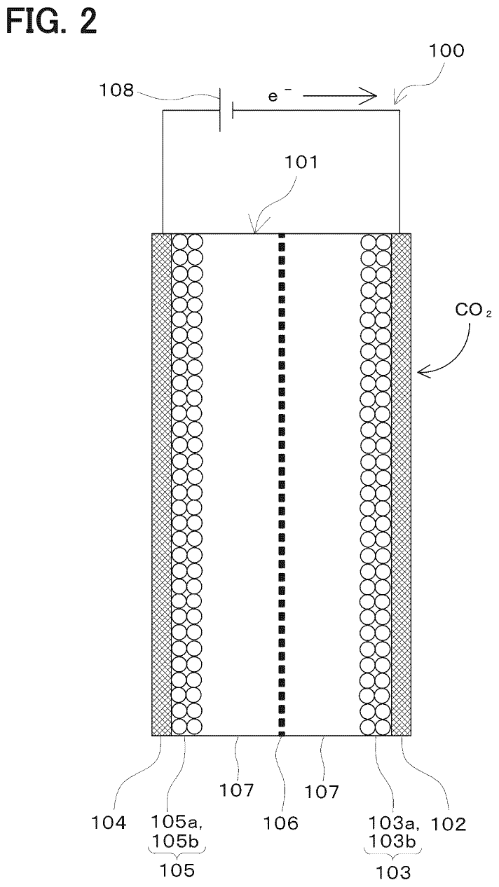

Next, the carbon dioxide recovery device 100 will be described with reference to FIG. 2. As shown in FIG. 2, the carbon dioxide recovery device 100 includes an electrochemical cell 101 configured to adsorb and desorb CO₂ by electrochemical reactions. The electrochemical cell 101 includes a working electrode current collector 102, a working electrode 103, a counter electrode current collector 104, a counter electrode 105, an insulating layer 106, and an electrolyte 107. The working electrode current collector 102, the working electrode 103, the counter electrode current collector 104, the counter electrode 105, and the insulating layer 106 are laminated.

The electrochemical cell 101 may be housed in a container (not shown). The container may define a gas inlet for introducing the CO₂-containing gas into the container and a gas outlet for discharging the CO₂-removed gas and CO₂ out of the container.

The carbon dioxide recovery device 100 is configured to adsorb and desorb CO₂ by the electrochemical reactions of the electrochemical cell 101, thereby separating and recovering CO₂ from the CO₂-containing gas. The carbon dioxide recovery device 100 includes a power supply 108 that applies a predetermined voltage to the working electrode 103 and the counter electrode 105, and can change a potential difference between the working electrode 103 and the counter electrode 105. The working electrode 103 is a negative electrode, and the counter electrode 105 is a positive electrode.

The electrochemical cell 101 can be switched between a CO₂ recovery mode in which CO₂ is recovered at the working electrode 103 and a CO₂ discharge mode in which CO₂ is discharged from the working electrode 103 by changing the potential difference between the working electrode 103 and the counter electrode 105. The CO₂ recovery mode is a charging mode for charging the electrochemical cell 101, and the CO₂ discharge mode is a discharging mode for discharging the electrochemical cell 101.

In the CO₂ recovery mode, a first voltage V1 is applied between the working electrode 103 and the counter electrode 105, and electrons flow from the counter electrode 105 to the working electrode 103. At the first voltage V1, the counter electrode potential is greater than the working electrode potential. The first voltage V1 may fall within a range from 0.5 to 2.0 V.

In the CO₂ discharge mode, a second voltage V2 is applied between the working electrode 103 and the counter electrode 105, and electrons flow from the working electrode 103 to the counter electrode 105. The second voltage V2 is different from the first voltage V1. The second voltage V2 is a voltage lower than the first voltage V1, and a magnitude relationship between the working electrode potential and the counter electrode potential is not limited. That is, in the CO₂ discharge mode, the working electrode potential may be lower than, equal to, or greater than the counter electrode potential.

The counter electrode current collector 104 is a porous conductive material having pores through which the CO₂-containing gas containing CO₂ can pass. As the counter electrode current collector 104, for example, a carbonaceous material or a metal material can be used. The carbonaceous material constituting the counter electrode current collector 104 may be, for example, carbon paper, carbon cloth, non-woven carbon mat, porous gas diffusion layer (GDL) and the like. The metal material constituting the counter electrode current collector 104 may be a mesh structure made of metal such as Al, Ni, or SUS (stainless steel).

The counter electrode 105 includes a counter electrode substrate 105a and a counter electrode active material 105b. The counter electrode substrate 105a is made of a conductive material and holds the counter electrode active material 105b. As the counter electrode substrate 105a, for example, a carbon sheet can be used. The counter electrode active material 105b is an auxiliary electroactive species that exchanges electrons with the working electrode 103.

The counter electrode active material 105b is an active material that gives and receives electrons by an oxidation-reduction reaction. The counter electrode active material 105b may be, for example, a metal complex that can receive and release electrons by changing a valence of a metal ion. Examples of such a metal complex include cyclopentadienyl metal complexes such as ferrocene, nickelocene, and cobaltocene, porphyrin metal complexes, and the like. These metal complexes may be polymers or monomers. In the present embodiment, as an example, polyvinylferrocene is used as the counter electrode active material 105b. Ferrocene transfers electrons by changing the valence of Fe between divalent and trivalent.

The counter electrode 105 may further include a conductive additive and a binder. The conductive additive forms a conductive path to the counter electrode active material 105b. For the conductive additive, for example, a carbon material such as carbon nanotube, carbon black, or graphene can be used.

The binder may be any material as long as it can hold the counter electrode active material 105b on the counter electrode substrate 105a and has conductivity. The binder may be a conductive resin such as an epoxy resin and a fluoropolymer, containing Ag or the like as a conductive filler. The fluoropolymer may be, for example, polytetrafluoroethylene (PTFE), or polyvinylidene fluoride (PVDF).

In the present embodiment, as an example, the counter electrode substrate 105a is formed in a porous structure. The counter electrode active material 105b, the conductive additive, and the binder are used in a mixed state. Specifically, a mixture of the counter electrode active material 105b, the conductive additive, and the binder is formed, and the mixture is applied to and bonded with the counter electrode substrate 105a. That is, the counter electrode active material 105b, the conductive additive, and the binder are mixed and applied to the counter electrode substrate 105a.

The working electrode current collector 102 is a conductive material. The working electrode current collector 102 may be made of the same material as the counter electrode current collector 104 described above.

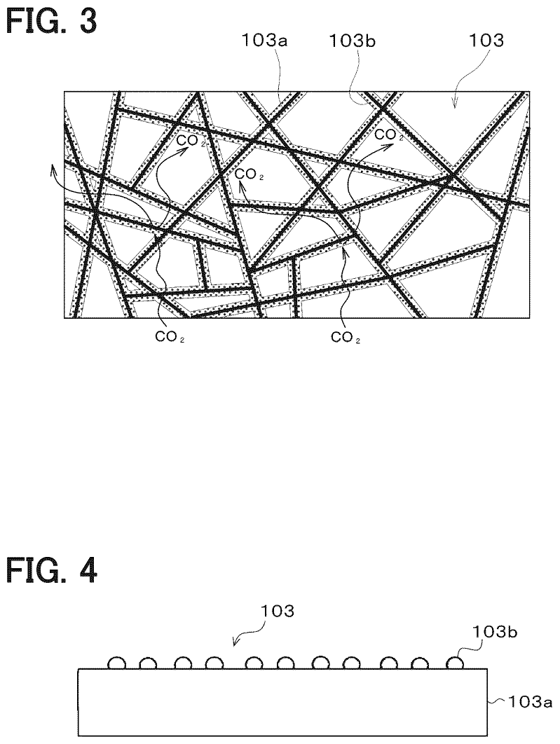

As shown in FIG. 3 and FIG. 4, the working electrode 103 includes a working electrode substrate 103a, which is a substrate of the electrode, and a CO₂ adsorbent 103b. The working electrode substrate 103a is a conductive material that holds the CO₂ adsorbent 103b. The working electrode substrate 103a is made of a non-carbon material. The working electrode substrate 103a may have a mesh structure made of metal such as SUS, Ti, or Ni. In the present embodiment, as an example, an SUS mesh made of SUS is used as the working electrode substrate 103a.

The CO₂ adsorbent 103b is an active material that gives and receives electrons by an oxidation-reduction reaction. The CO₂ adsorbent 103b adsorbs CO₂ by receiving electrons and desorbs the adsorbed CO₂ by releasing electrons.

The CO₂ adsorbent 103b is made of an inorganic material. In the present embodiment, the CO₂ adsorbent 103b contains a metal oxide. The metal oxide contained in the CO₂ adsorbent 103b may be, for example, a Cu containing oxide such as Cu₂O or CuO. In the present embodiment, the CO₂ adsorbent 103b contains Cu₂O as an example.

The average particle size of the CO₂ adsorbent 103b is not particularly limited, but is preferably on the submicron (100 nm) order, and more preferably, for example, 30 nm or more and 80 nm or less. The smaller the particles of the CO₂ adsorbent 103b, the greater the total surface area of the CO₂ adsorbent 103b held on the working electrode substrate 103a. Therefore, the CO₂ adsorbent 103b held on the working electrode substrate 103a can adsorb a large amount of CO₂.

The working electrode 103 does not contain at least one of a carbon-containing conductive additive and a carbon-containing binder. As an example, the working electrode 103 of the present embodiment does not contain either a carbon-containing conductive additive or a carbon-containing binder. Therefore, the CO₂ adsorbent 103b is directly supported on the working electrode substrate 103a. In the present disclosure, the terms “a carbon-containing conductive additive” and “a carbon-containing binder” mean “a conductive additive containing carbon” and “a binder containing carbon”, respectively.

As described above, the working electrode 103 of the present embodiment includes the working electrode substrate 103a made of a non-carbon material and the CO₂ adsorbent 103b made of an inorganic material and does not contain either a carbon-containing conductive additive or a carbon-containing binder. Therefore, the working electrode 103 of the present embodiment is substantially free of carbon.

In the present disclosure, “substantially free of carbon” means that the amount of carbon in the total amount of the working electrode 103 is less than 0.1 mass %, and carbon is not intentionally added. This refers to a level of carbon that may be unavoidably introduced. That is, in the present disclosure, “substantially free of carbon” may also apply to a case in which carbon derived from organic matter in air is detected when analyzed by X-ray photoelectron spectroscopy (XPS) or the like.

The insulating layer 106 is disposed between the working electrode 103 and the counter electrode 105 and separates the working electrode 103 and the counter electrode 105 from each other. The insulating layer 106 is an insulating ion permeable membrane that prevents physical contact between the working electrode 103 and the counter electrode 105 to restrict an electrical short circuit and that allows ions to permeate therethrough.

As the insulating layer 106, a separator or a gas layer such as air can be used. In the present embodiment, a porous separator is used as the insulating layer 106. As the material of the separator, a cellulose membrane, a polymer, a composite material of a polymer and a ceramic, or the like can be used.

An electrolyte 107 having ionic conductivity is provided between the working electrode 103 and the counter electrode 105. The electrolyte 107 is provided between the working electrode 103 and the counter electrode 105 via the insulating layer 106. The electrolyte 107 is provided to cover the working electrode 103, the counter electrode 105 and the insulating layer 106.

As an example, in the present embodiment, the electrolyte 107 has an aprotic property. The electrolyte 107 having an aprotic property is an electrolyte that does not donate protons (H⁺). Therefore, charges do not move to the electrolyte 107 due to proton generation, and the decrease in current efficiency during CO₂ adsorption can be restricted.

An ionic liquid can be used as the electrolyte 107 having an aprotic property. The ionic liquid is a salt in a liquid state having non-volatility under normal temperature and pressure. When the ionic liquid is used as the electrolyte 107, the ionic liquid may be gelled to prevent elution of the ionic liquid from the electrochemical cell 101. As the ionic liquid having an aprotic property, [BMIM][TFSI], [TMPA][TFSI], [Pyrro][TFSI], [BMIM][Tfb], [EMIM][TFSI], or the like can be used.

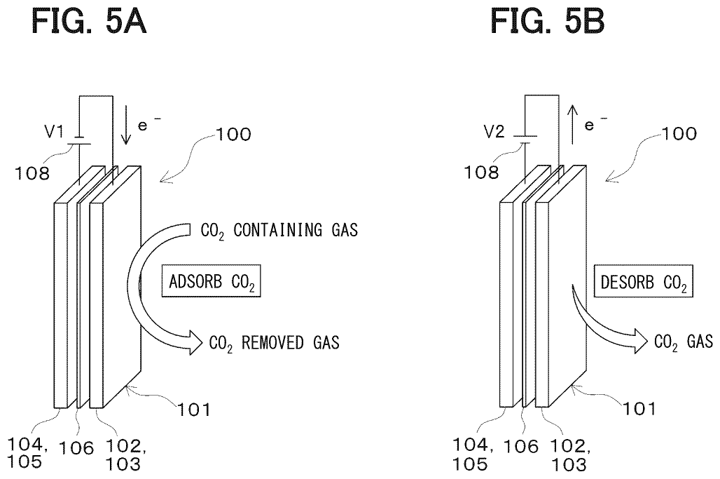

Next, the operation of the carbon dioxide recovery system 10 of the present embodiment will be described. The carbon dioxide recovery system 10 operates by alternating switching between the CO₂ recovery mode shown in FIG. 5A and the CO₂ discharge mode shown in FIG. 5B. The operation of the carbon dioxide recovery system 10 is controlled by the controller 14.

First, the CO₂ recovery mode will be described. In the CO₂ recovery mode, the compressor 11 operates to supply the CO₂-containing gas to the carbon dioxide recovery device 100. In the carbon dioxide recovery device 100, the voltage applied between the working electrode 103 and the counter electrode 105 is the first voltage V1. This makes it possible to simultaneously realize electron donation of the counter electrode 105 and electron attraction of the working electrode 103.

The counter electrode active material 105b of the counter electrode 105 discharges electrons to be oxidized, and the electrons are supplied from the counter electrode 105 to the working electrode 103. The CO₂ adsorbent 103b of the working electrode 103 receives electrons and adsorbs CO₂. In the present embodiment, CO₂ is adsorbed to the working electrode 103 in a state of being converted into at least one selected from a group consisting of CO₂⁻, C₂O₄²⁻, and HCO₃⁻. Thus, the carbon dioxide recovery device 100 can recover CO₂ from the CO₂-containing gas.

After CO₂ is recovered from the CO₂-containing gas by the carbon dioxide recovery device 100, the CO₂-containing gas is discharged from the carbon dioxide recovery device 100 as the CO₂-removed gas containing no CO₂. The flow path switching valve 12 switches the flow path of exhaust gas toward the atmosphere, and the CO₂-removed gas from the carbon dioxide recovery device 100 is discharged to the atmosphere.

Next, the CO₂ discharge mode will be described. In the CO₂ discharge mode, the operation of the compressor 11 is stopped, and the supply of the CO₂-containing gas to the carbon dioxide recovery device 100 is stopped. In the carbon dioxide recovery device 100, the voltage applied between the working electrode 103 and the counter electrode 105 is set to the second voltage V2. As a result, electron donation of the CO₂ adsorbent 103b of the working electrode 103 and electron attraction of the counter electrode active material 105b of the counter electrode 105 can be realized at the same time.

The CO₂ adsorbent 103b desorbs and releases CO₂. CO₂⁻, C₂O₄²⁻, and HCO₃⁻ adsorbed by the CO₂ adsorbent 103b are desorbed in a state of being converted into CO₂.

The CO₂ released from the CO₂ adsorbent 103b is discharged from the carbon dioxide recovery device 100. The flow path switching valve 12 switches the flow path of the exhaust gas toward the carbon dioxide utilizing device 13, and the CO₂ discharged from the carbon dioxide recovery device 100 is supplied to the carbon dioxide utilizing device 13.

The present disclosure will be described in more detail below using examples, but the present disclosure is not limited to the examples described below.

### Method for Producing Working Electrode

The present inventors prepared the working electrode 103 according to the procedures described in the following Experimental Examples 1 and 2. In Experimental Example 1, a working electrode 103 (hereinafter also referred to as a Cu₂O/SUS mesh working electrode) was produced using an SUS mesh as the working electrode substrate 103a and Cu₂O as the CO₂ adsorbent 103b, according to the following procedure. Hereinafter, the SUS mesh used as the working electrode substrate 103a will also be referred to as an SUS mesh substrate, and the Cu₂O used as the CO₂ adsorbent 103b will also be referred to as an Cu₂O adsorbent.

First, the SUS mesh substrate was subjected to a hydrophilic treatment. Specifically, the SUS mesh substrate was ultrasonically cleaned with acetone and then heat-treated at 350° C. for 1 hour.

Next, the Cu₂O adsorbent was precipitated on the surface of the SUS mesh substrate using a polyol reduction method. The polyol reduction method is a method in which metal oxides or salts are heated and reduced in a polyol to precipitate metal-containing fine particles.

Specifically, first, 4500 mg of copper nitrate, 600 ml of ethylene glycol, and 30 mg of cysteamine were placed in a round flask, for example, to prepare a copper nitrate solution. Copper nitrate is a raw material, ethylene glycol functions as a reducing agent, and cysteamine functions as a dispersing agent.

Subsequently, the SUS mesh substrate that had been subjected to the hydrophilic treatment was immersed in the copper nitrate solution and heated to 147° C. using a mantle heater or the like. At this time, nuclei of Cu₂O adsorbent were formed on the surface of the SUS mesh substrate in the copper nitrate solution due to the polyol reduction reaction. That is, fine particles of the Cu₂O adsorbent were precipitated on the surface of the SUS mesh substrate.

The SUS mesh substrate on which the Cu₂O adsorbent had been precipitated was then immersed in 2-propanol for cleaning, and then dried in a vacuum at 60° C. As a result, the Cu₂O/SUS mesh working electrode was obtained. Hereinafter, the Cu₂O/SUS mesh working electrode produced by this production method will also be referred to as a Cu₂O/SUS mesh working electrode of Experimental Example.

Experimental Example 2 was the same as Experimental Example 1 except that a Ti mesh or a Ni mesh was used as the working electrode substrate 103a of the working electrode 103. In Experimental Example 2, when the polyol reduction method was carried out, fine particles of the Cu₂O adsorbent and fine particles of Cu were precipitated on the surface of the Ti mesh or Ni mesh substrate.

### Shape Observation and Composition Analysis

The present inventors observed the geometric shape of the Cu₂O/SUS mesh working electrode of Experimental Example using a scanning electron microscope (SEM). The inventors also calculated the average particle size by measuring the diameter of the particles in the SEM image. In the present embodiment, measurements were performed using an S-5500 (manufactured by Hitachi High-Technologies Corporation), and the average particle diameter was derived by randomly picking out 50 particles from the measured SEM field of view, measuring particle diameters thereof, and calculating the average value.

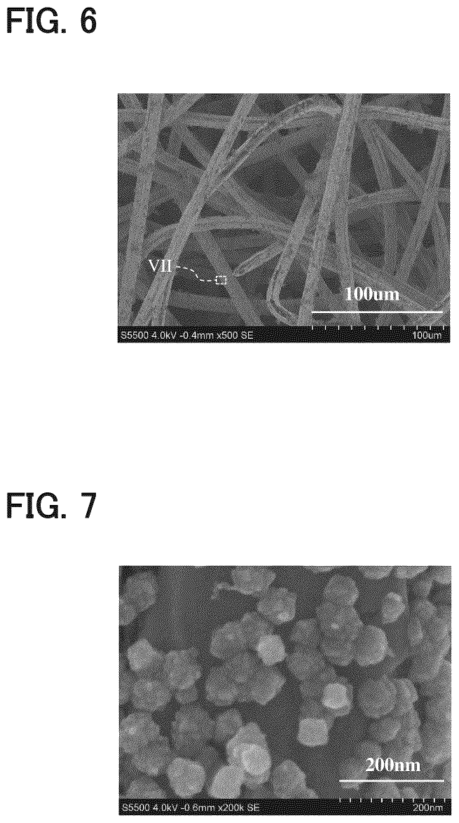

The results are shown in FIG. 6 and FIG. 7. As is clear from FIG. 6 and FIG. 7, it was confirmed that CO₂ adsorbent 103b having an average particle size of 60 nm was formed on the SUS mesh substrate (that is, the working electrode substrate 103a).

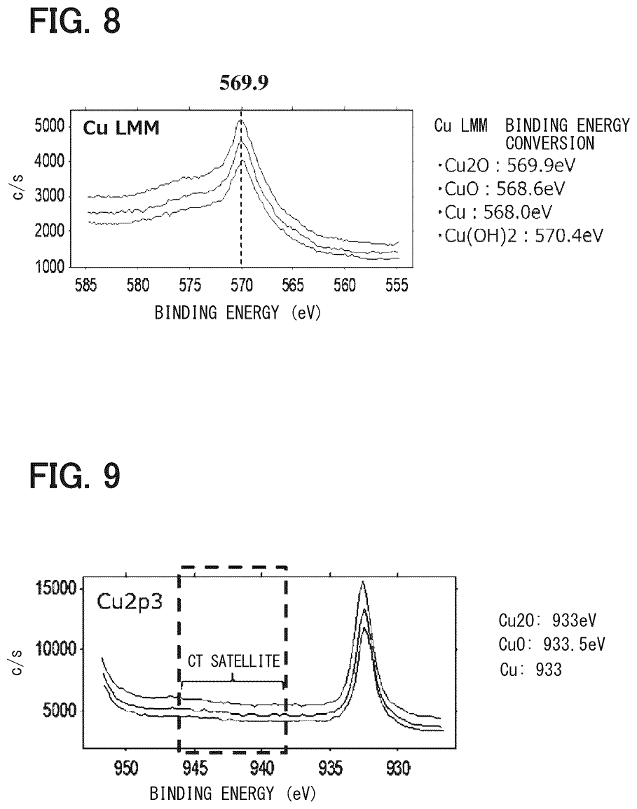

Next, the inventors performed a composition analysis of the CO₂ adsorbent 103b (hereinafter also referred to as the CO₂ adsorbent 103b of Experimental Example) formed on the SUS mesh substrate in the Cu₂O/SUS mesh working electrode of Experimental Example. Specifically, the CO₂ adsorbent 103b of Experimental Example was analyzed by X-ray photoelectron spectroscopy (XPS). The results are shown in FIG. 8 and FIG. 9. FIG. 8 shows the LMM Auger electron peak of Cu, and FIG. 9 shows the 2p_{3/2} photoelectron peak of Cu.

As shown in FIG. 8, the LMM Auger electron peak of Cu in the CO₂ adsorbent 103b of Experimental Example includes at least a peak due to Cu₂O.

As shown in FIG. 9, in the LMM Auger electron peak of Cu, a region surrounded by a dashed line is a region where a peak called a CT satellite is observed. The CT satellite is also called a charge transfer satellite.

The CT satellite is a satellite structure resulting from the bonding of Cu and O. In the process of emitting photoelectrons, electrons are transferred from the 2p orbital of O to the 3d orbital of Cu, and this process can be detected as the satellite structure by XPS. That is, if the object to be analyzed contains CuO, a peak is observed in the CT satellite of the LMM Auger electron peak of Cu.

Here, in the XPS analysis results of the CO₂ adsorbent 103b of Experimental Example, as shown in FIG. 9, no peak was detected in the CT satellite. Therefore, it was shown that the CO₂ adsorbent 103b of Experimental Example did not contain CuO and was composed of Cu₂O.

The above shape observation and composition analysis showed that in the Cu₂O/SUS mesh working electrode of Experimental Example, a Cu₂O adsorbent (that is, the CO₂ adsorbent 103 b) with an average particle size of 60 nm was formed on the SUS mesh substrate (that is, the working electrode substrate 103a).

### XRD Measurement

Subsequently, the present inventors performed X-ray diffraction (XRD) measurements on the particles precipitated on the surface of the working electrode substrates 103a in the working electrodes 103 of Experimental Examples 1 and 2, and collected the corresponding XRD patterns.

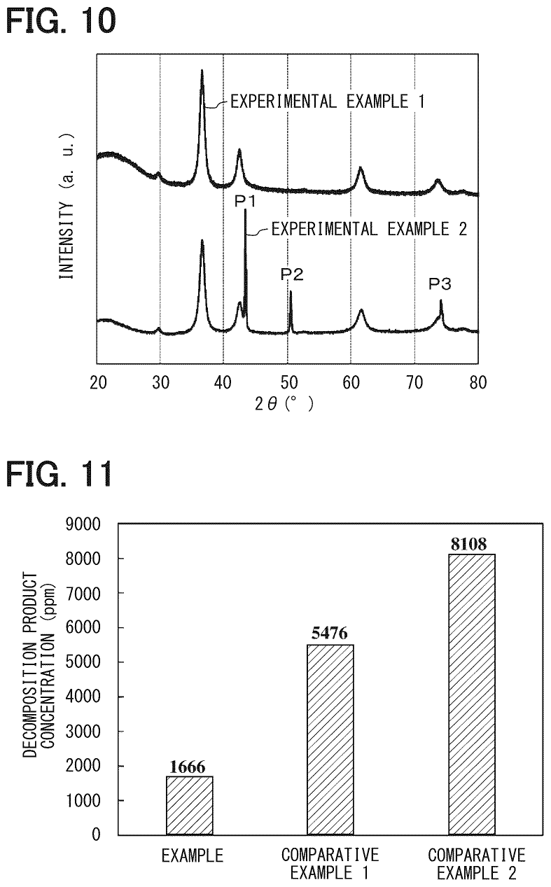

Specifically, for each of the working electrodes 103 of Experimental Examples 1 and 2, the particles precipitated on the surface of the working electrode substrate 103a were physically peeled off from the working electrode substrate 103a and subjected to XRD measurement in a powder state. The results are shown in FIG. 10. In FIG. 10, the upper graph shows the diffraction pattern of Experimental Example 1, and the lower graph shows the diffraction pattern of Experimental Example 2.

As shown in FIG. 10, the diffraction pattern of Experimental Example 1 was equivalent to the simulated pattern of Cu₂O powder. Therefore, in the working electrode 103 of the Experimental Example 1, it was shown that Cu₂O was precipitated on the surface of the working electrode substrate 103a.

In the diffraction pattern of the Experimental Example 2, peaks indicated by P1 to P3 were confirmed in addition to the diffraction pattern of Cu₂O powder. When the XRD pattern was compared with the database, it was found that the peaks indicated by P1 to P3 were derived from Cu metal. Therefore, in the working electrode 103 of the Experimental Example 2, it was shown that Cu was precipitated on the surface of the working electrode substrate 103a in addition to Cu₂O.

### Decomposition Product Concentration Measurement

The present inventors measured the concentration of decomposition products during CO₂ recovery when the Cu₂O/SUS mesh working electrode was used as the working electrode 103 of the electrochemical cell 101. In the present disclosure, the decomposition product concentration is the concentration of CO in the recovered CO₂. Specifically, first, electrochemical cells 101 of Example and Comparative Examples 1, 2 were prepared as follows.

In the electrochemical cell 101 of Example, the working electrode 103 uses SUS felt (manufactured by Nippon Seisen Co., Ltd.) as the working electrode substrate 103a, and Cu₂O as the CO₂ adsorbent 103b. The working electrode 103 of Example is formed by precipitating Cu₂O on the surface of SUS felt by the polyol reduction method described above. The working electrode 103 of Example 1 does not contain either a binder or a conductive additive.

In this example, the counter electrode 105 uses SUS mesh (manufactured by Nikko Techno Co., Ltd.) as the counter electrode substrate 105a, carbon nanotubes as the conductive additive, and polyvinylferrocene (manufactured by Nard) as the counter electrode active material 105b. A separator (manufactured by Whatman) was used as the insulating layer 106. [TMPA][TFSI] was used as the electrolyte 107.

The electrochemical cell 101 of Comparative Example 1 was the same as the electrochemical cell 101 of Example, except that the configuration of the working electrode 103 was changed as follows. That is, in Comparative Example 1, the working electrode 103 uses SUS felt (manufactured by Nippon Seisen Co., Ltd.) as the working electrode substrate 103a, Cu₂O as the CO₂ adsorbent 103b, Ketjen black as the conductive additive, and PVDF as the binder. The working electrode 103 of Comparative Example 1 was formed by applying a mixture of Cu₂O, Ketjen black, and PVDF onto SUS felt.

The electrochemical cell 101 of Comparative Example 2 was similar to the electrochemical cell 101 of Comparative Example 1, except that the CO₂ adsorbent 103b was omitted.

Next, the decomposition product concentrations when CO₂ adsorption/desorption was performed in the electrochemical cells 101 of Example and Comparative Examples 1 and 2 were measured. The decomposition product concentrations were measured by the following procedure.

The electrochemical cell 101 to be measured was placed in a housing, and the inside of the housing was purged with N₂, after which a mixed gas of 500 ppm CO₂/dry air was introduced to adjust the CO₂ concentration. Thereafter, the enclosure was sealed and the decomposition product concentration was measured.

In measuring the decomposition product concentration, a constant voltage was applied to the electrochemical cell 101 to perform adsorption and desorption of CO₂. Specifically, the adsorption voltage was set to −0.9 V, the desorption voltage was set to +0.2 V, and the adsorption time and desorption time were each set to 30 minutes.

When the constant voltage was applied to the electrochemical cell 101 to adsorb and desorb CO₂, the amount of CO₂ recovered by the electrochemical cell 101 was measured by measuring the amount of CO₂ inside the housing with a CO₂ sensor. In the present disclosure, the amount of CO₂ inside the housing that houses the electrochemical cell 101 is referred to as the “amount of CO₂ in the housing.”

When CO₂ adsorption by the electrochemical cell 101 is performed in the housing, the amount of CO₂ inside the housing decreases. When CO₂ desorption by the electrochemical cell 101 is performed in the housing, the amount of CO₂ inside the housing increases. Therefore, the decrease amount of the amount of CO₂ inside the housing corresponds to the CO₂ adsorption amount of the electrochemical cell 101, and the increase amount of the amount of CO₂ inside the housing corresponds to the CO₂ desorption amount of the electrochemical cell 101.

Similarly, when the constant voltage was applied to the electrochemical cell 101 to adsorb and desorb CO₂, the amount of CO generated as a decomposition product was measured by measuring the amount of CO inside the housing with a CO sensor. Then, the ratio of the amount of CO generated to the amount of CO₂ recovered (that is, the amount of CO₂ adsorbed) was calculated to determine the CO concentration in the recovered CO₂. The results are shown in FIG. 11.

As shown in FIG. 11, the decomposition product concentration in the electrochemical cell 101 of Example was ⅓ or less of the decomposition product concentration in the electrochemical cell 101 of Comparative Example 1, and was ¼ or less of the decomposition product concentration in the electrochemical cell 101 of Comparative Example 2. Therefore, it was confirmed that, in the electrochemical cell 101 of Example that is free of carbon, the decomposition product was significantly reduced compared to the electrochemical cells 101 of Comparative Examples 1 and 2.

As described above, in the working electrode 103 of the electrochemical cell 101 of the present embodiment, the working electrode substrate 103a is made of a non-carbon material, and the CO₂ adsorbent 103b is made of an inorganic material. The working electrode 103 does not contain either a carbon-containing conductive additive or a carbon-containing binder. Therefore, the working electrode 103 of the present embodiment is substantially free of carbon. Accordingly, it is possible to suppress the occurrence of decomposition reactions between the working electrode 103 and oxygen, water, or the like present in the electrolyte 107. That is, it is possible to suppress the decomposition of the working electrode 103 caused by its reaction with oxygen, water, or the like in the electrolyte 107.

In the electrochemical cell 101, the smaller the particle diameter of the CO₂ adsorbent 103b, the larger the total surface area, and therefore the larger the amount of CO₂ that can be adsorbed. However, nanoparticles are generally commercially available as agglomerated powders of several microns in size, and it is difficult to disperse them to the submicron (that is, 100 nm) order and apply them to a substrate.

In contrast, the manufacturing method of the working electrode 103 in the present embodiment includes precipitating the Cu₂O adsorbent on the surface of the SUS mesh substrate in the polyol solution by the polyol reduction reaction. Accordingly, it becomes possible to arrange submicron-order Cu₂O adsorbent over the entire surface of the SUS mesh substrate. As a result, the CO₂ adsorbent 103b held on the working electrode 103 can adsorb a large amount of CO₂.

### Second Embodiment

The following describes a second embodiment of the present disclosure. The second embodiment differs from the first embodiment in that the working electrode 103 contains a conductive additive 103c. Hereinafter, only portions different from the first embodiment are described.

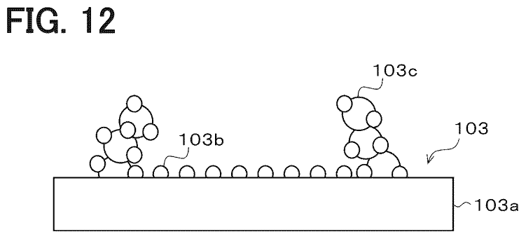

As shown in FIG. 12, the working electrode 103 of the present embodiment includes the working electrode substrate 103a, the CO₂ adsorbent 103b, and the conductive additive 103c. The conductive additive 103c forms a conductive path to the CO₂ adsorbent 103b. For the conductive additive 103c, for example, a carbon material such as carbon nanotube, carbon black, or graphene can be used.

The conductive additive 103c is supported on the working electrode substrate 103a. The CO₂ adsorbent 103b may be supported directly on the working electrode substrate 103a or may be supported on the conductive additive 103c. In the present embodiment, as an example, the CO₂ adsorbent 103b is supported on both the working electrode substrate 103a and the conductive additive 103c. The other configurations are similar to those of the first embodiment.

Therefore, the working electrode 103 of the present embodiment can also provide the same effects as those of the first embodiment. That is, according to the present embodiment, it is possible to suppress the occurrence of decomposition reactions between the working electrode 103 and oxygen, water, or the like present in the electrolyte 107. Furthermore, in the present embodiment, since the conductive additive 103c is provided on the working electrode 103, the conductivity of the working electrode 103 can be improved.

### Other Embodiments

The present disclosure is not limited to the embodiments described above, and can be variously modified as follows without departing from the gist of the present disclosure.

For example, the above-described embodiments described examples in which air is used as the CO₂-containing gas, but the present disclosure is not limited to this example. The CO₂-containing gas may be any gas that contains CO₂, such as exhaust gas from an internal combustion engine.

In the second embodiment, the working electrode 103 is provided with the working electrode substrate 103a, the CO₂ adsorbent 103b, and the conductive additive 103c. However, the working electrode 103 is not limited to this example. For example, the working electrode 103 may be provided with the working electrode substrate 103a, the CO₂ adsorbent 103b, and a binder. In this case, the working electrode 103 does not contain the conductive additive 103c. As the binder, a conductive resin such as an epoxy resin containing Ag or the like as a conductive filler, or a fluororesin such as PTFE or PVDF may be used.

What is claimed is:

1. A working electrode comprising:
a substrate and a CO₂ adsorbent supported by the substrate, wherein
the CO₂ adsorbent is configured to bind to CO₂ contained in a CO₂-containing gas in response to an application of a voltage between a counter electrode and the working electrode, which causes electrons to be supplied from the counter electrode to the CO₂ adsorbent,
the substrate is made of a non-carbon material,
the CO₂ adsorbent is made of an inorganic material, and
the working electrode is substantially free of carbon.

2. The working electrode according to claim 1, wherein the working electrode does not contain at least one of a conductive additive containing carbon or a binder containing carbon.

3. The working electrode according to claim 1, wherein the CO₂ adsorbent is directly supported on the substrate.

4. The working electrode according to claim 1, wherein the CO₂ adsorbent contains a metal oxide.

5. The working electrode according to claim 4, wherein the CO₂ adsorbent contains a Cu containing oxide.

6. The working electrode according to claim 5, wherein the CO₂ adsorbent contains Cu₂O or CuO.

7. The working electrode according to claim 1, wherein the substrate is made of stainless steel, Ti or Ni.

8. The working electrode according to claim 1, wherein the CO₂ adsorbent has an average particle size of 30 nm or more and 80 nm or less.

9. An electrochemical cell comprising:
a working electrode that includes a substrate and a CO₂ adsorbent supported by the substrate;
a counter electrode; and
an electrolyte that covers the working electrode and the counter electrode, wherein
the CO₂ adsorbent is configured to bind to CO₂ contained in a CO₂-containing gas in response to an application of a voltage between the counter electrode and the working electrode, which causes electrons to be supplied from the counter electrode to the CO₂ adsorbent,
the substrate is made of a non-carbon material,
the CO₂ adsorbent is made of an inorganic material,
the working electrode is substantially free of carbon, and
the electrolyte is an ionic liquid.

10. The electrochemical cell according to claim 9, wherein
the ionic liquid has an aprotic property.

11. A manufacturing method of a working electrode that includes a substrate and a CO₂ adsorbent supported by the substrate, wherein
the CO₂ adsorbent is configured to bind to CO₂ contained in a CO₂-containing gas in response to an application of a voltage between a counter electrode and the working electrode, which causes electrons to be supplied from the counter electrode to the CO₂ adsorbent,
the substrate is made of a non-carbon material,
the CO₂ adsorbent is made of an inorganic material, and
the working electrode is substantially free of carbon,
the manufacturing method comprising precipitating the CO₂ adsorbent on a surface of the substrate in a polyol solution by a polyol reduction reaction.
